(19) United States
(12) Patent Application Publication
(10) Pub. No.: US 2013/0318182 A1
(43) Pub. Date: Nov. 28, 2013

(54) TARGETED LOCATION-BASED MESSAGING

(71) Applicants: Prasasth Reddy Palnati, Westford, MA (US); Sanjeev Jain, North Chelmsford, MA (US)

(72) Inventors: Prasasth Reddy Palnati, Westford, MA (US); Sanjeev Jain, North Chelmsford, MA (US)

(21) Appl. No.: 13/900,572

(22) Filed: May 23, 2013

Related U.S. Application Data
(60) Provisional application No. 61/651,952, filed on May 25, 2012.

(51) Int. Cl. H04L 12/58

(52) U.S. Cl. CPC H04L 51/20
USPC 709/206

(57) ABSTRACT

Methods and apparatus, including computer program products, for targeted location-based messaging. A method includes, in a server residing in a network of interconnected computers, the server including a processor and a memory, maintaining a repository of content, receiving geolocation information from a mobile device, determining appropriate content to be sent to the mobile device according to the received geolocation location information, and sending the appropriate content to the mobile device for projection on to a projection surface.

### CROSS REFERENCE TO RELATED APPLICATIONS

This application claims the benefit of U.S. Provisional Application No. 61/651,952, filed May 25, 2012. The disclosure of the prior application is considered part of and is incorporated by reference in the disclosure of this application.

### BACKGROUND OF THE INVENTION

The present invention generally relates to messaging, and more particularly to targeted location-based messaging.

Mobile marketing and location-based marketing is reaching a tipping point. While mobile marketing has been around for a while, advances in technology have moved them on considerably over the past few years. Now mobile phones are critical to people's daily lives and how they organize their world, whether its socializing, keeping in contact with people via social media, organizing business or engaging in some form of mobile commerce. That's a trend that will only continue well into the future.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for targeted location-based messaging.

In general, in one aspect, the invention features a method including, in a server residing in a network of interconnected computers, the server including a processor and a memory, maintaining a repository of content, receiving geolocation information from a mobile device, determining appropriate content to be sent to the mobile device according to the received geolocation location information, and sending the appropriate content to the mobile device for projection on to a projection surface.

In another aspect, the invention features a method including, in a mobile device including a processor, a memory, and a projection system, determining a geographic position, sending the geographic position to a server residing a network of interconnected computers, receiving content from the server related to the geographic position, and projecting the received content with the projection system on to a projection surface.

In still another aspect, the invention features a method including, in a server residing in a network of interconnected computers, receiving an identification number (ID) and Global Positioning System (GPS) coordinates from a mobile device, determining a location of the mobile device from the GPS coordinates, retrieving profile information for the mobile device according to the ID, determining search parameters for identifying relevant content from an inventory of content, retrieving the relevant content from the inventor, and sending the retrieved relevant content to the mobile device for projection on to a projection surface proximate to the mobile device.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 is a block diagram of an exemplary platform.

FIG. 2 is a block diagram of an exemplary projection.

FIG. 3 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

One or more of the following terms may be referred to in the description that follows.

A “mobile device” refers to a wireless device that combines a phone capability with a projection capability. Example mobile devices include, for example, smart phones, tablet PCs, personal data assistants (PDAs), e-book readers, and so forth.

“Real estate” refers to a projection surface.

“Property” includes the real estate, e.g., a vehicle (property) includes a window (real estate).

“Content” may refer to one of any text, audio, video and or combination therefore, such as advertising.

A “content provider” provides content.

A “target audience” is one or more people who are in a position to see the display on the real estate.

A “property owner” refers for an owner of the real estate, such as a person/corporation that owns/operates the property.

A “system” generally refers to an entire collection of physical objects and associated software, such as servers, advertisement networks, Internet, mobile devices, mobile networks, projection surfaces, property, and so forth.

Methods and apparatus of the present invention provide a system (i.e., two-sided platform) that enables a delivery and display of content on the real estate of a stationary or moving property such as, for example, an automobile. More specifically, the present invention is a platform that delivers targeted location-based dynamic content originating from a server to remote device locations proximate to a target audience for display. The content is displayed on a variety of projection surfaces, such as a window of a vehicle. The display of the content is non-disruptive, i.e., there is no need for any special attachments at the remote locations. For projection on glass surfaces, a film (passive or active) may be utilized.

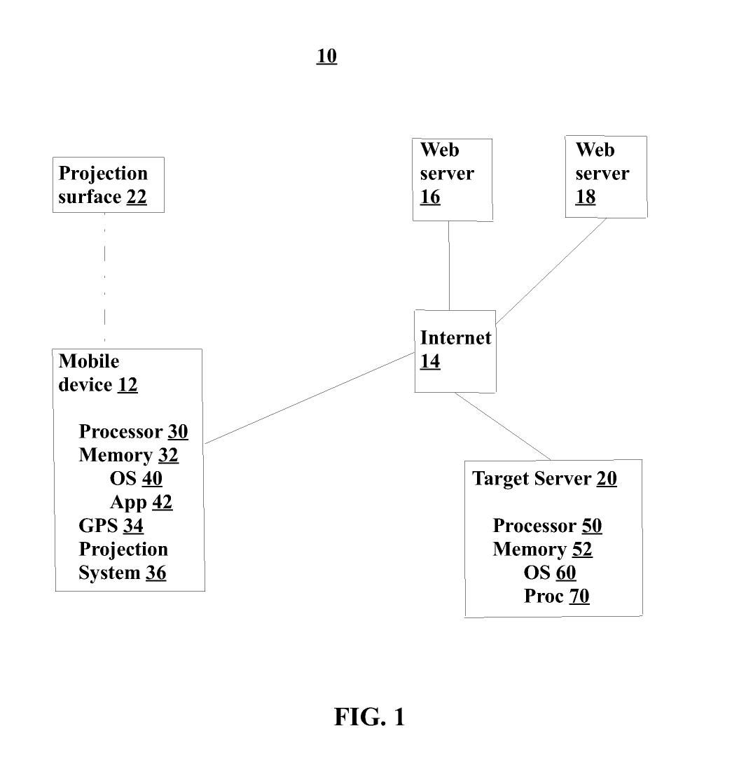

As shown in FIG. 1, a platform 10 includes a mobile device 12 linked wirelessly to a group of interconnected computers 14 (e.g., the Internet). The Internet 14 includes one or more web servers 16, 18 and a target server 20. The platform 10 also includes a projection surface 22 on which a content projection originating from the mobile device 12 may be projected.

The mobile device 12 can include a processor 30, a memory 32, a global positioning system (GPS) system 34, and a projection system 36. The memory 32 includes an operating system 40, such as Apple IOS®, Google Android® or Microsoft Windows Mobile®, and a mobile location-based content projection application (App) 42. The mobile device 12 may support any one of various mobile technologies, such as 2G, 2.5G, 3G and 4G/LTE, along with supporting SMS messaging (i.e., texting) and data exchange.

The target server 20 can include a processor 50, a memory 52 and a repository 54 of content. The memory 52 includes an operating system 60, such as Linux® or Windows®, and a mobile location-based content projection process 70. In one embodiment, the mobile location-based content projection process 70 interacts with the mobile location-based content projection App 42 to project content residing in the repository 54 on to the projection surface 22.

In another embodiment, the mobile location-based content projection process 70 interacts with the mobile location-based content projection app 42 to project content residing in the one or more servers 16,18 on to the projection surface 22. In one implementation, content is obtained from the one or more servers 16, 18 through an Application Programming interface (API). In addition, content providers (e.g., advertisers) linked to the target server 20 and/or the one or more web servers 16, 18 may add content to the repository 54 through a web-based graphical user interface (GUI). Thus, it is possible that the content is processed through the target server 20 but not stored. For simplicity, we use the word repository in the rest of the description.

The displayed content is selected by the mobile location-based content projection process 70 based on a current location of the mobile device 12, a current local clock time corresponding to the location of the mobile device 12 and/or a best match from an inventory of content in the repository 54 or the one or more web servers 16, 18. The content in the repository 54 is updated in a dynamic fashion.

A location of the mobile device is defined by its current global positioning system (GPS) coordinates (i.e., latitude, longitude, altitude), which may be supplemented with further positional information, such as a surrounding neighborhood, a street name, a highway location, a proximity to mall/airport/hotels/stadiums, nearby businesses, and so forth.

As described above, content as used herein refers to any digital media, such as text, audio, video, pictures/images, and so forth. In general, content is any message whose target audience is likely to see it when displayed on the projection surface 22. In one specific embodiment, the content is one or more advertisements.

Projection surfaces 22 include a wide variety of surfaces defined herein as real estate. For example, real estate may include a car window, a bus window, a showroom display window, a glass front office door or window, and so forth. In general, real estate is any place where a display may be projected from the mobile device 12.

The mobile device 12 is typically rigidly mounted within a specific environment. The mobile device 12, in one embodiment, is a wireless smart phone with the projection system 36 enabling a capability of displaying content, e.g., a message, on an appropriate projection surface 22, such as a window in a vehicle. In this embodiment, the displayed message is readable from an outside of the window. The projection is unlike traditional projections. Traditional projections display messages on the surface closest to the projector for viewing from the same side as the projector. The present invention projects content such that message viewing is from the other side of the surface (e.g., outside surface of a car window when the mobile device is mounted inside the car). In some embodiments, a film is placed on the projection surface 22 to enable such exterior viewing.

In operation, the mobile device 12 informs the target server 20 about its location. If the target server 20 has appropriate deliverable content, the target server 20 sends the content to the mobile device 12. The mobile device 12 receives the content and projects/displays it on the projection surface 22. The mobile device 12 may also communicate back information to the target server 20, which may generate a variety of reports.

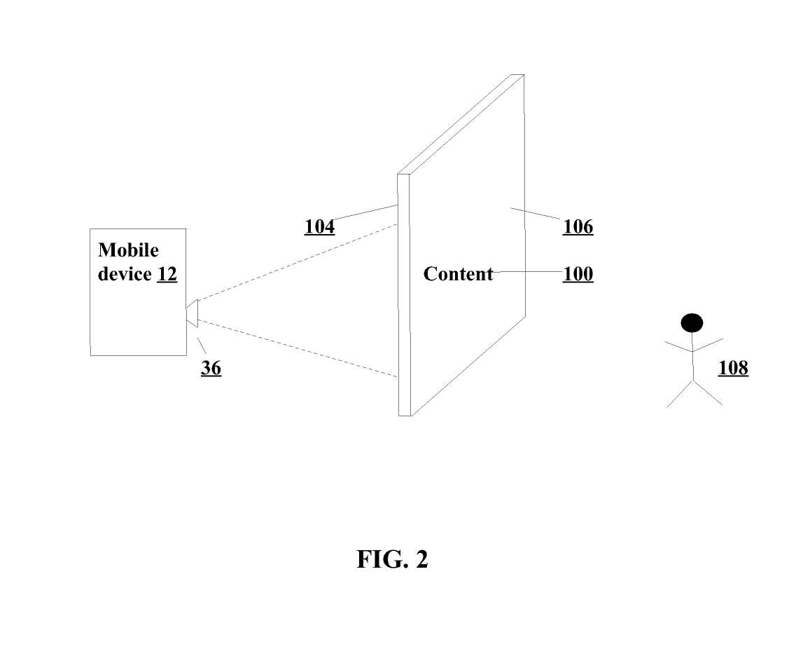

As shown in FIG. 2, in one example, digital content is displayed on the window 102 (i.e., projection surface) of a vehicle in a non-disruptive manner without the need for any special attachments or defacing vehicle exteriors (like painting, stickers, and so forth). The mobile device's projection system 36 projects the content on a first side 104 of the projection surface 102 and it is displayed on a second side 106 of the projection surface 102 for viewing by a subject 108.

In one embodiment, the target server 20 has an inventory of content in the repository 54 from sources such as advertisers who would like to target an audience in a specific geographic area. For example, an upscale fashion brand may want to advertise in Boston's Newbury Street area during specified time periods. The advertiser can upload their content through a web-based graphical user interface (GUI) with specific instructions about locations, number of impressions, and, possibly, a target time window. The target server 20 identifies suitable mobile devices that are on Newbury Street during the time specified by advertiser using geolocation information and displays the content specified by the advertiser for the time and place. In another example, local restaurants looking to promote a special promotion to people who are in a specific area can place their content in the repository 54 through a Web-based graphical user interface (GUI) and specify locations and time when their content should appear displayed.

Mobile devices, such as mobile device 12, periodically communicate with the target server 20 to provide their location information so the target server 20 knows the location of the mobile devices in different geographic areas. If target server 20 finds a match between a content provider (e.g., an advertiser) looking to display (e.g., advertise) in a specific area and one or more mobile devices are in the area during that specific time, the content (e.g., advertisement) is sent to the mobile device that is residing in a property and the mobile device displays the advertised content via projection on the real estate. If no message is found in inventory, a default message may be displayed.

In another embodiment, the target server 20 may interface with advertisement networks that are part of the Internet 14 to source the inventory in the repository 54. The API provides information such that advertisement networks can provide relevant messaging for display. Relevant messaging may be local, regional, national or global advertisement to be displayed.

The platform 10 described above has inputs and outputs. Example inputs include the following.

Each mobile device 12 is assigned a unique identification (ID) associated with a specific profile. The ID may be a phone number, a media access control (MAC) address, a 32-bit unique ID assigned per device, and so forth.

For each property owner, a profile identifies the owner (e.g., name, address, and so forth) and also specifies owner preferences, such as, no political messages, only display messages in certain time windows, and so forth. Property owners have their own access to servers using a web-based graphical user interface (GUI) for profile management and other activities.

Each displayed message is based on a unique ID, current location, current local time, and/or profile, elected from content inventory (or content residing on the one or more web servers 16, 18) and sent to the mobile device 12 for display. The duration of any one content display is variable and system-controllable.

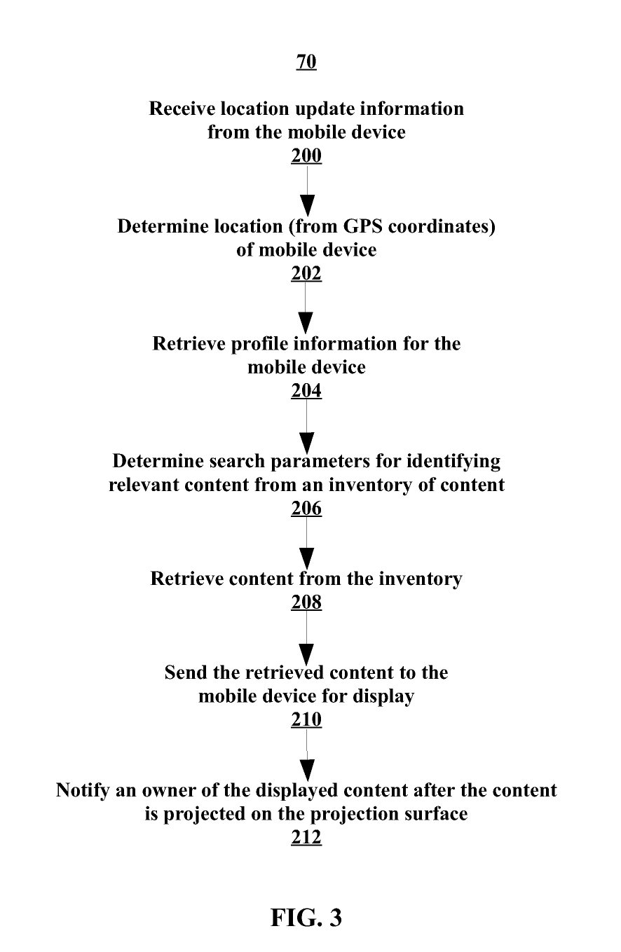

As shown in FIG. 3, the mobile location-based content projection process 70 includes receiving (200) location update information from the mobile device. Receiving (200) may be by polling one or more the mobile devices or by the one or more mobile devices sending their respective location information to the target server.

The mobile location-based content projection process 70 determines (202) location (from GPS coordinates) and whether the property is stationary or moving. Stationary GPS coordinates imply a non-moving mobile device while changing GPS coordinates imply a moving mobile device. For example, a vehicle can be moving or parked, while a store-front window is stationary.

The mobile location-based content projection process retrieves (204) profile information for the mobile device and determines (206) search parameters for identifying relevant content from a stored inventory.

The mobile location-based content projection process uses the search parameters to retrieve (208) content from the inventory and optionally, from other advertising networks. The retrieved message is selected based on a variety of parameters, such as price, location of the mobile device, a number of target/contracted impressions, a real estate owner's profile, preferred provider relationships and so forth. A default criterion is to select a message from a provider that pays the most for display.

The mobile location-based content projection process sends (210) the retrieved content to the mobile device for display along with the duration of display.

The mobile location-based content projection process notifies (212) an owner of the displayed content after the content is projected on the projection surface.

In one embodiment, the mobile location-based content projection process 70 notifies an owner of the projection surface after the message is projected on the projection surface.

The present invention is driven by context and relevance that addresses the future of advertising and marketing. The present invention is a combination of cellular wireless technologies and internet based advertising and marketing that enhances the use of location-based marketing techniques to reach target audiences in a dynamic fashion.

As previously noted, the hardware and software systems in which the invention is illustrated are merely representative. The invention may be practiced, typically in software, on one or more machines. Generalizing, a machine typically comprises commodity hardware and software, storage (e.g., disks, disk arrays, and the like) and memory (RAM, ROM, and the like). The particular machines used in the system are not a limitation of the present invention. A given machine includes network interfaces and software to connect the machine to a network in the usual manner. The present invention may be implemented as a standalone product, or as a managed service (e.g., in an ASP model) using a set of machines, which are connected or connectable to one or more networks. More generally, the product or service is provided using a set of one or more computing-related entities (systems, machines, processes, programs, libraries, functions, or the like) that together facilitate or provide the inventive functionality described above. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, .ASP), and a set of applications or processes (e.g., Java applets or servlets, linkable libraries, native code, or the like, depending on platform), that provide the functionality of a given system or subsystem. As described, the product or service may be implemented in a standalone server, or across a distributed set of machines. Typically, a server connects to the publicly-routable Internet, a corporate intranet, a private network, or any combination thereof, depending on the desired implementation environment.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While given components of the system have been described separately, one of ordinary skill will appreciate that some of the functions may be combined or shared in given instructions, program sequences, code portions, and the like.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. Accordingly, other implementations are within the scope of the following claims.

What is claimed is:

1. A method comprising:
in a server residing in a network of interconnected computers, the server comprising a processor and a memory, maintaining a repository of content;
receiving geolocation information from a mobile device;
determining appropriate content to be sent to the mobile device according to the received geolocation location information; and
sending the appropriate content to the mobile device for projection on to a projection surface.

2. The method of claim 1 wherein the mobile device comprises:
a processor;
a memory, the memory comprising an operating system and a mobile location-based content projection app;
a global positioning system (GPS) system; and
a projection system.

3. The method of claim 1 wherein content is selected from the group consisting of text, audio, video, pictures and images.

4. A method comprising:
in a mobile device comprising a processor, a memory, and a projection system, determining a geographic position;
sending the geographic position to a server residing a network of interconnected computers;
receiving content from the server related to the geographic position; and
projecting the received content with the projection system on to a projection surface.

5. The method of claim 4 wherein projecting comprises displaying the received content for a specified period of time.

6. The method of claim 4 further comprising notifying an owner of the received content.

7. The method of claim 4 further comprising notifying an owner of the projection surface.

8. A method comprising:
in a server residing in a network of interconnected computers, receiving an identification number (ID) and Global Positioning System (GPS) coordinates from a mobile device;
determining a location of the mobile device from the GPS coordinates;
retrieving profile information for the mobile device according to the ID;
determining search parameters for identifying relevant content from an inventory of content;
retrieving the relevant content from the inventor; and
sending the retrieved relevant content to the mobile device for projection on to a projection surface proximate to the mobile device.

9. The method of claim 8 further comprising notifying an owner of he relevant contact.

10. The method of claim 8 further comprising notifying an owner of the projection surface.

11. The method of claim 8 wherein the inventory resides is a repository maintained by the server.

12. The method of claim 8 wherein the inventory resides in one or more content servers linked to the network of interconnected computers.

13. The method of claim 8 wherein the inventory of content is selected from the group consisting of text, audio, video, pictures and images.

14. The method of claim 8 wherein the search parameters are selected from the group consisting of price, location of mobile device, number of targeted/contracted impressions, an owner of the projection surface profile and a preferred provider relationship.

15. The method of claim 8 wherein the relevant content is a message from a provider that paid the most for a display.

16. The method of claim 8 wherein the ID is selected from the group consisting of a mobile device telephone number, a media access controller (MAC) address and a unique number assigned to the mobile device.

17. The method of claim 8 wherein the a projection surface is associated with an owner's profile.

18. The method of claim 17 wherein the owner's profile comprises:
a name;
an address;
time preferences; and
owner message preferences.

19. The method of claim 8 further comprising receiving updates to inventory of content through Graphical User Interface resident in one or more servers linked to the network of interconnected computers.
